(19) United States
(12) Patent Application Publication
(10) Pub. No.: US 2009/0133640 A1
(43) Pub. Date: May 28, 2009

(54) BARK CONTROL DEVICE AND FABRICATION PROCESS THEREOF

(75) Inventor: Weimin Bai, Shenzhen (CN)

Correspondence Address: BUCHANAN, INGERSOLL & ROONEY PC, POST OFFICE BOX 1404, ALEXANDRIA, VA, 22313-1404, US

(73) Assignee: Pets & Supplies Hong Kong Limited, Kowloon (CN)

(21) Appl. No.: 12/297,792

(22) PCT Filed: Apr. 20, 2007
(86) PCT No.: PCT/IB2007/001036

§ 371 Date: Oct. 20, 2008

(30) Foreign Application Priority Data
Apr. 20, 2006 (CN) 06104761.3

(51) Int. Cl. A01K 15/00; B23P 17/04

(52) U.S. Cl. 119/718; 29/428

(57) ABSTRACT

A device for deterring a dog from barking includes a sensor for detecting a bark from a dog and for generating an activation signal upon detection of the bark and an integral housing. The integral housing includes a reservoir for storing a bark deterrent substance, a bobbin integrated with the reservoir, a wall separating the bobbin from the reservoir, and an aperture extending through the wall for allowing fluid communication between the reservoir and the bobbin. The device further includes a spray mechanism for delivery of a dose of the bark deterrent substance to the dog upon receipt of the activation signal from the sensor.

### FIELD OF THE INVENTION

The present invention relates to the field of bark control devices for a dog. More particularly, the present invention relates to an apparatus for controlling the barking of pet dogs, and to a fabrication process thereof.

### BACKGROUND OF THE INVENTION

Most pet owners are aware of the problems associated with controlling the barking of a pet dog. Dogs naturally bark for many reasons such as to signal other dogs, to define their territory, to communicate excitement or fear and to warn prior to an attack.

Where dogs are kept on large tracts of land, such as farms, the barking of a dog is generally not considered a nuisance. Instead, it may be regarded as a signal of an event requiring the attention of the landowner, for example, a person approaching or a strange animal in the area. However, where a dog owner lives in an area closely proximate to other people, the barking of a dog can become a nuisance to both the dog owner and the neighbors.

Various techniques and devices have been developed to control the barking of a dog. Such devices include ultrasonic devices which emit an ultrasonic signal hardly detectable to the human ear yet intolerable to a dog. These devices are either worn by a dog or placed nearby and upon detecting the barking of a dog emit the ultrasonic signal.

Other devices include shock-type device worn around the neck of a dog and include a pair of electrodes adapted to contact the voice box region of a dog's neck which upon detection of vibrations from the dog's voice box indicative of barking, provide a small static shock to the dog in order to deter the dog from barking.

Other examples of bark deterrent and control devices include those worn by a dog and which emit a deterrent substance in a gaseous or liquid form towards the olfactory senses of a dog upon sensing that the dog is barking. One such device is that as disclosed by, U.S. Pat. No. 6,668,760, entitled “Spray control anti-bark collar” and issued to Groh, et al. on Dec. 30, 2003. This document discloses a spray bark control device having a vibration sensor for generating an activation signal responsive to the bark of the dog. A spray mechanism delivers a controlled dose of a deterrent substance upon receipt of the activation signal. The spray delivery mechanism includes a valve and solenoid assembly, in connection with a reservoir containing a deterrent substance, which is held under pressure, to direct the deterrent spray at the olfactory senses of the dog.

It is an object of the present invention to provide a bark control device or a manufacturing process thereof, which overcomes at least some of the deficiencies exhibited by some of those of the prior art.

### SUMMARY OF THE INVENTION

In a first aspect, there is provided a device for deterring a dog from barking, comprising:
a sensor for detecting a bark from a dog and for generating an activation signal upon detection of the bark;
an integral housing including a reservoir for storing a bark deterrent substance, a bobbin integrated with the reservoir, a wall separating the bobbin from the reservoir, and an aperture extending through the wall for allowing fluid communication between the reservoir and the bobbin; and
a spray mechanism for delivery of a dose of the bark deterrent substance to the dog upon receipt of the activation signal from the sensor.

Preferably, the integral housing is formed from a unitary polymeric molding.

The bobbin preferably includes a valve assembly bobbin, and an extension tube extending from the valve assembly bobbin.

The spray mechanism preferably includes a valve assembly installed with the valve assembly bobbin for providing controlled delivery of the dose of bark deterrent substance to the dog.

More preferably, the spray mechanism further includes windings wound around the extension tube, the winding being for generation of an electromagnetic field upon receipt of the activation signal so as to controllably operate the valve assembly.

According to a second aspect of the present invention, there is provided a process of fabricating a device for deterring a dog from barking, the process comprising,
providing an integral housing having a reservoir for storage of a bark deterrent substance, a bobbin integrated with the reservoir, a wall extending between the bobbin and the reservoir, and an aperture extending through the wall for allowing fluid communication between the reservoir and the bobbin; and
providing a spray mechanism in the bobbin for delivery of a dose of the bark deterrent substance to a dog upon receipt of an activation signal generated by a sensor upon sensing a bark from the dog.

Preferably, the process comprises forming the integral housing from a unitary molded polymeric material.

Preferably, the bobbin includes a valve assembly bobbin, and an extension tube extending from the valve assembly bobbin.

The process preferably further comprises installing a valve assembly in the valve assembly bobbin for controllably delivering the dose of the bark deterrent substance to the dog.

More preferably, process further comprises providing windings around the extension tube, the windings being adapted to generate an electromagnetic field upon receipt of the activation signal so as to controllably operate the valve assembly.

In a further aspect, the present invention provides a device for deterring a dog from barking comprising:
a reservoir portion for containment of a pressurized bark deterrent substance;
   a bobbin portion defining a chamber therein, the chamber of the bobbin being in fluid communication with the reservoir portion via an aperture extending therebetween and for delivery of bark deterrent substance to the olfactory senses of a dog upon sensing that the dog is barking;
a sensor for detecting a bark from a dog and for generating an activation signal upon detection of the bark; and
a valve assembly located within the chamber of the bobbin, said valve assembly being adapted to deliver a dose of bark control substance upon receipt of an activation signal from the sensor.

The reservoir portion and bobbin portion are preferably unitarily formed and passage therebetween provided by the aperture is provided by the aperture extending from the chamber of the bobbin portion through an intermediate formation between the bobbin portion and reservoir portion and into the reservoir portion.

Preferably the reservoir portion substantially defines a housing of the device, and the bobbin portion extends from within the reservoir portion to external of the housing. More preferably, the housing, reservoir portion and bobbin portion are integrally formed as a unitary structure. The housing, reservoir portion and bobbin portion may be integrally formed as a unitary structure.

The valve assembly preferably includes a biased plunger located within the passage of the bobbin wherein the plunger is biased and adapted to seal the aperture absent receiving an activation signal from the sensor to allow for pressurisation of the deterrent substance within the reservoir portion.

Preferably the valve assembly further includes a valve having a discharge channel in fluid communication with a nozzle for discharge of deterrent substance.

The plunger is preferably provided so as to seal both the discharge channel and the aperture absent receiving an activation signal from the sensor.

Preferably the valve assembly includes a solenoid coil for effecting operation of the valve upon receipt of an activation signal from the sensor.

Other aspects and advantages of the invention will become apparent from the following detailed description, taken in conjunction with the accompanying drawings, which description illustrates by way of example the principles of the invention.

### BRIEF DESCRIPTION OF THE DRAWINGS

The invention now will be described, by way of example only, and with reference to the accompanying drawings in which:

FIG. 1a is a block diagram of an exemplary bark control device according to the present invention;

FIG. 1b is a perspective view showing an integrated reservoir/spray assembly of the exemplary bark control device of FIG. 1a;

FIG. 1c is an exploded view, from a different direction, showing part of the integrated reservoir/spray assembly of FIG. 1b;

FIG. 1d illustrates, in partial section, showing part of the integrated reservoir/spray assembly of FIG. 1b;

FIG. 2a shows a perspective view of an embodiment of a bark control device according to the present invention;

FIG. 2b shows a further perspective view of the embodiment depicted in FIG. 2a;

FIG. 2c shows another perspective view of the bark control device as depicted in FIGS. 2a and 2b and a refill valve in a disassembled arrangement;

FIG. 2d shows the bark control device and the refill valve as depicted in FIG. 2c in an assembled arrangement;

FIG. 2e shows another perspective view of the bark control device as depicted in FIGS. 2a and 2b and a reservoir cover in a disassembled arrangement;

FIG. 2f shows the bark control device and the reservoir cover as depicted in FIG. 2e in an assembled arrangement;

FIG. 2g shows yet another perspective view of the bark control device of the present embodiment depicted in an exploded arrangement; and

FIG. 2h shows the bark control device of FIG. 2g depicted in an assembled state.

### DETAILED DESCRIPTION

The following description refers to preferred embodiments of a bark control device of the present invention. To facilitate an understanding of the invention, reference is made in the description to the accompanying drawings whereby the bark control device is illustrated in preferred embodiments. Similar components between the drawings are identified by the same reference numerals.

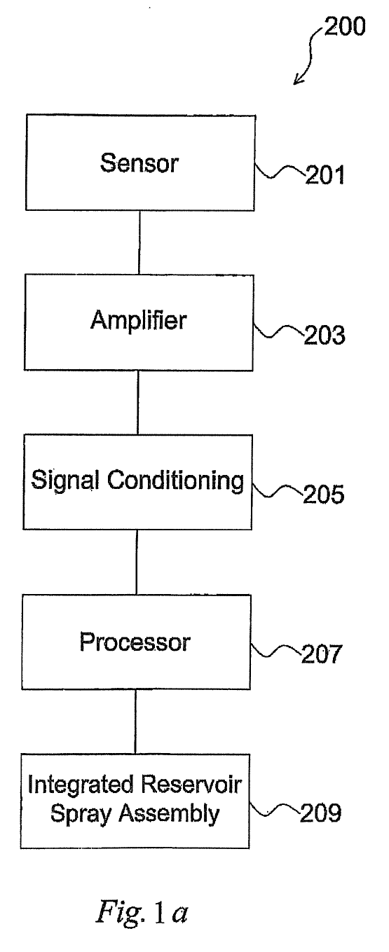

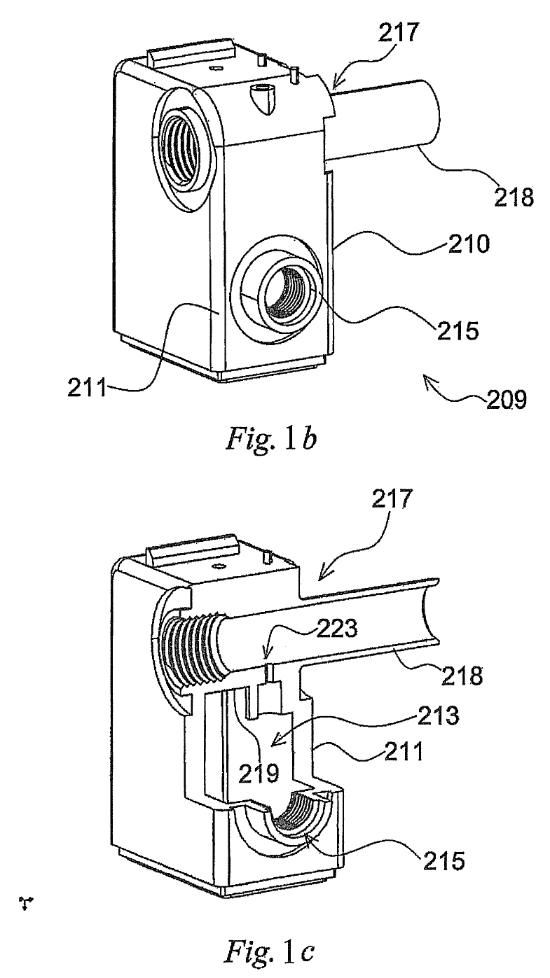

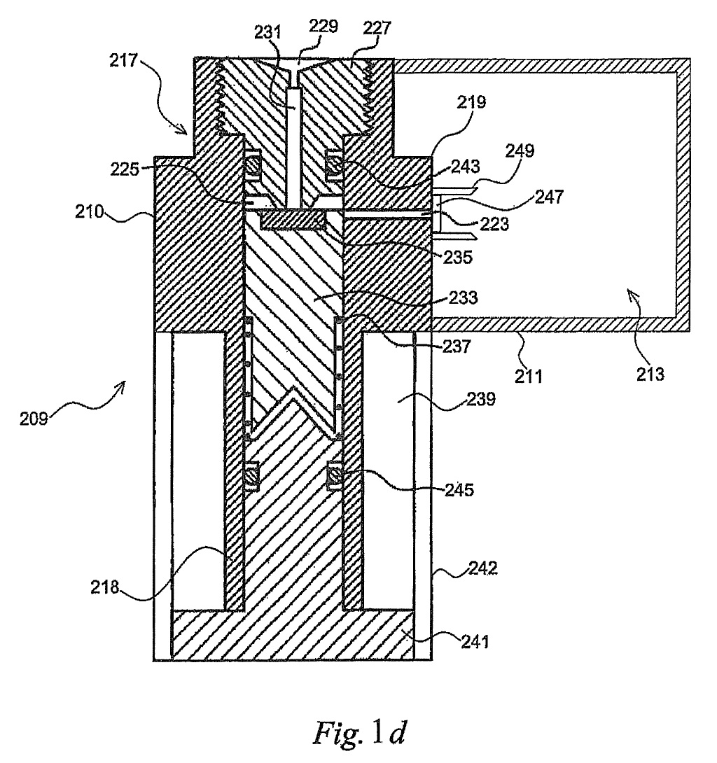

Referring to the drawings, FIG. 1a illustrates a block diagram of an exemplary bark control device 200 of the present invention. The device 200 includes a sensor 201 responsive to the bark of a dog. In one embodiment, the sensor 201 is a piezoelectric vibration sensor that is typically placed in contact with the throat of the dog so as to measure vibrations produced by the vocal cords of the dog. An amplifier 203 amplifies the output of the sensor 201 to increase the level of the sensor output for further processing and accurate sampling.

Depending upon the application and the desired level of sophistication of the bark detection circuit, the amplifier output may be processed to condition the signal by an optional signal conditioning circuit 205. The signal conditioning circuit 205 may also serve to discriminate between the vibrations measured by the vibration sensor so as to pass only measured vibrations that meet specified criteria. Those skilled in the art will recognize the various filters, amplifiers and other signal conditioning devices that can be used to prepare the measured vibrations for further processing. Those skilled in the art will recognize that the type of signal conditioning depends upon the input signal, the corresponding sensor and the desired characteristics of the input signal that are to be monitored. For example, the filter may be active or passive and may be set to pass a specific frequency range or remove high or low frequency noise. Further, depending upon the various components used, the output signal may not require additional amplification. Finally, other conditioning may be required to present a useable sensor output to the remainder of the circuit.

A controller or processing device 207 monitors the amplified output and activates the integrated reservoir and spray assembly 209 as necessary. Decision-making logic within the processor 207 determines whether a stimulus is needed. Typically, the input to the processor 207 is compared against a reference value to determine whether a stimulus is warranted. A conventional processing device includes an internal timer, memory registers and math capabilities allowing sophisticated signal processing to occur; however, those skilled in the art will recognize that these capabilities can be achieved using other components without departing from the spirit and scope of the present invention. Further, those skilled in the art will recognize that the components used to depend on various factors including the cost of manufacture, size and weight constraints and the complexity of the decision process. For example, the size and weight of the bark training collar worn by the animal is reduced by implementing the controller in a single application specific integrated circuit (ASIC) or a microprocessor, both of which allow complex decision making capabilities. For lower cost, larger units implementing a simple decision tree, an array of discrete logic components can be used.

In the illustrated embodiment, the integrated reservoir and spray assembly 209 delivers a controlled dose of a deterrent substance, or fluid, as necessary. The deterrent substance is selected to be irritating or disturbing to the dog. A commonly used deterrent stimulus is a citronella liquid; however, those skilled in the art will recognize other deterrent substances that can be used without departing from the scope and spirit of the present invention, for example compressed air or water. In addition, those skilled in the art will recognize that the sound of the substance escaping under pressure provides a secondary deterrent function.

With reference to FIGS. 1b-1d, the integrated reservoir and spray assembly 209 firstly has an integral housing 210, formed by a molded single piece of plastic. The integral housing 210 exhibits a generally square shape with a hollow bobbin 217, which functions as a valve and solenoid bobbin for housing various vale and solenoid components. The bobbin 217 extends through the upper portion of the housing 210, with an extension 218 protruding outside. A reservoir 211 is formed in the lower portion of the integral housing 210, with a chamber 213 inside for storing the deterrent substance which is held under pressure, which can be refilled through a refill valve 215. The valve and solenoid bobbin 217 and the reservoir 211 are separated by a wall 219 such that the chamber 213 is defined. A delivery passage 223 extends through the wall and thereby provides fluid communication between the bobbin 217 and the chamber 213.

As shown in FIG. 1d, the bobbin 217 defines an axial through opening 225 creating a passage for fluid transfer. The through opening 225 is threaded at one end and receives a threaded valve 227. Those skilled in the art will recognize that the valve can be secured to the bobbin 217 in other ways without departing from the scope and spirit of the present invention. For example, it is contemplated that the valve can be integrally formed with the bobbin or could be secured using solder, welds, crimps, set screws, or adhesives.

The valve 227 includes a valve output, or nozzle, 229 in communication with a discharge channel 231 that is in communication with the internal volume of the bobbin 217. A plunger 233 rests in the through opening 225 below the valve 227. The plunger 233 includes a seal 235 configured to engage with and seal the discharge channel 231 that opens to the interior volume of the bobbin 217. The seal 235 is formed from a suitable material that is flexible such that when the seal 235 is brought into engagement with the valve 227, the discharge channel 231 is effectively closed so that no fluid can escape through the valve 227. In the illustrated embodiment, the plunger 233 is shown in a closed position. A spring 237 biases the plunger 233 to maintain the closed position. To open the valve 227, activated by the controller 207 (see FIG. 1a), the bias of the spring 237 is overcome using the solenoid by passing current through the windings 239 wound around the extension 218 of the bobbin 217. This creates an electromagnetic field that pulls the plunger 233 back against the stopper 241, thereby allowing the pressurized deterrent substance to enter the discharge channel 231 via the delivery passage 223 and escape through the valve 208. A tube 242, surrounding the windings 239 and preferably being a metal tube, is attached to the housing 210 to keep the windings 239 and stopper 241 in position.

The pressurized deterrent substance enters the volume of the bobbin 217 through delivery passage 223, which is on the wall 219 between the reservoir 211 and the bobbin 217. In the illustrated embodiment, the delivery passage 223 appears to be partially blocked by the plunger 233; however, the present invention does not require that the inlet of the delivery passage 223 be sealed. The integrated assembly 209 is designed such that the deterrent substance can fill the volume around the plunger and spring. A pair of gaskets or O-rings 243, 245 forms the seal that limits the expansion of the deterrent substance and maintains the fluid pressure within the integrated assembly 209. Those skilled in the art will recognize that other configurations can be used without departing from the scope and spirit of the present invention.

In addition, a filter 247 within a tube 249 can be added to cover the delivery passage 223 for preventing flow-in of dusts into the chamber 213.

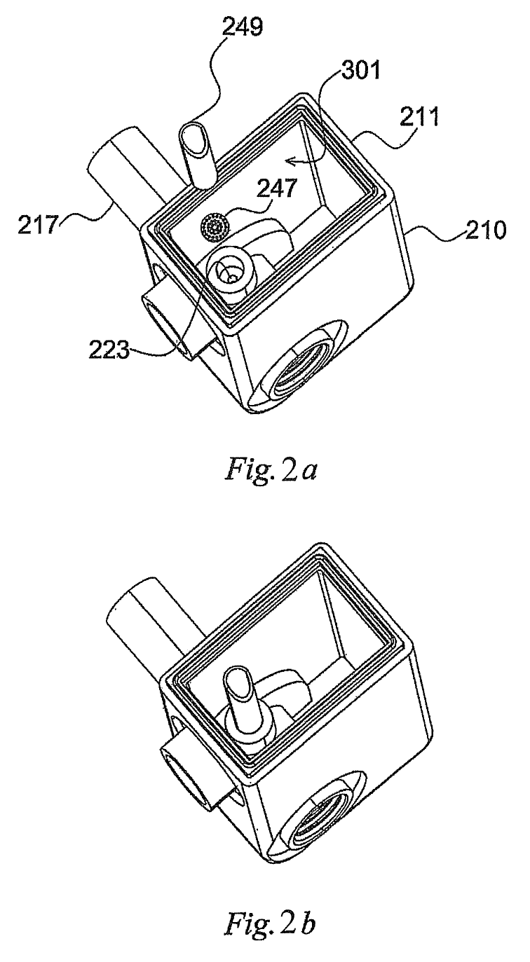

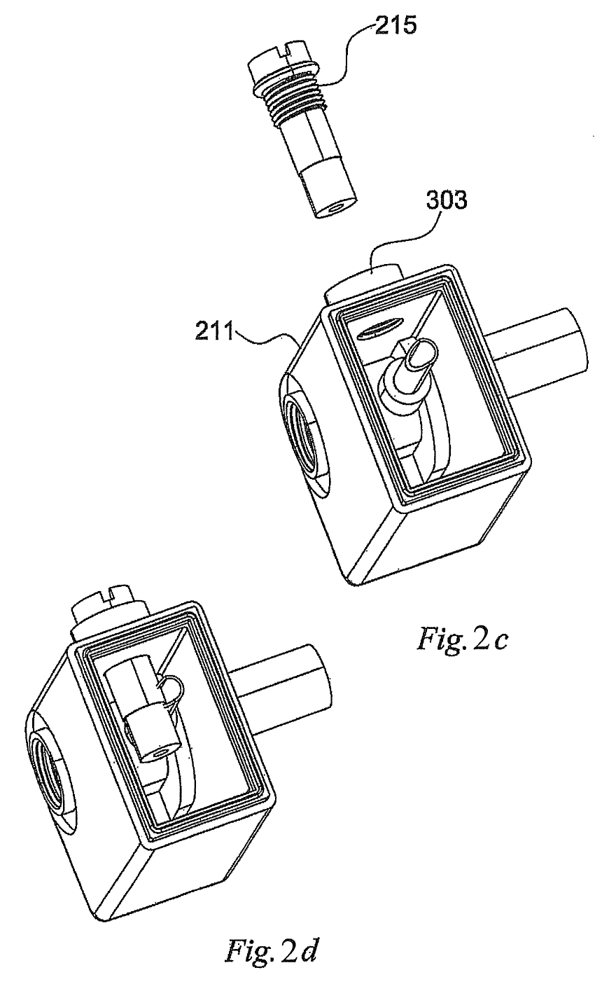

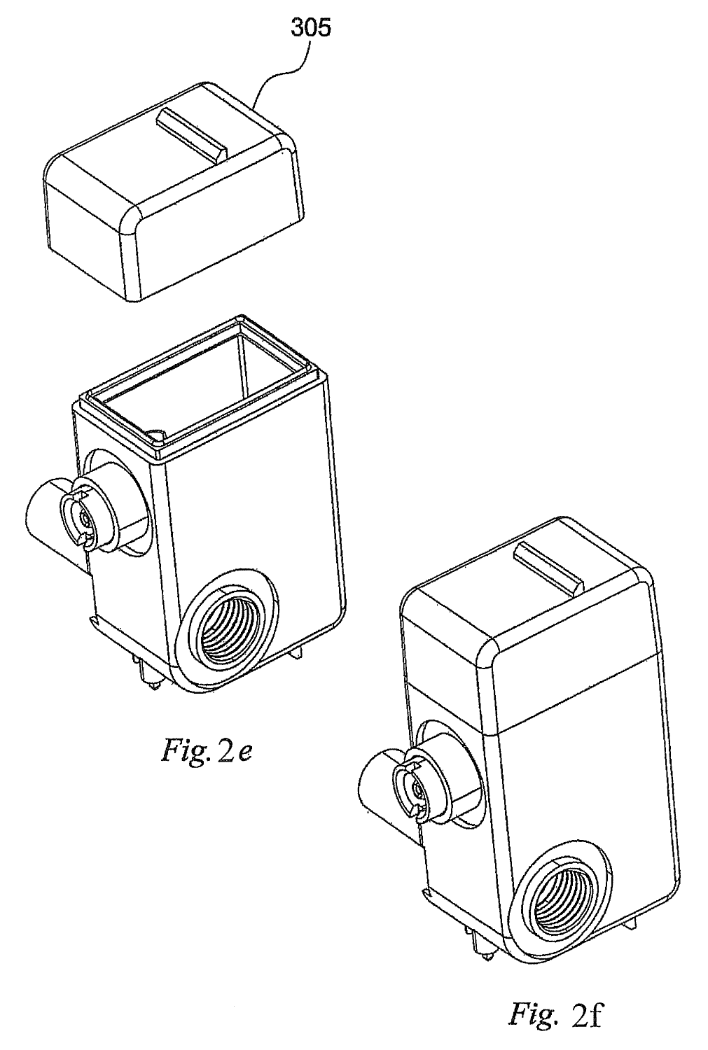

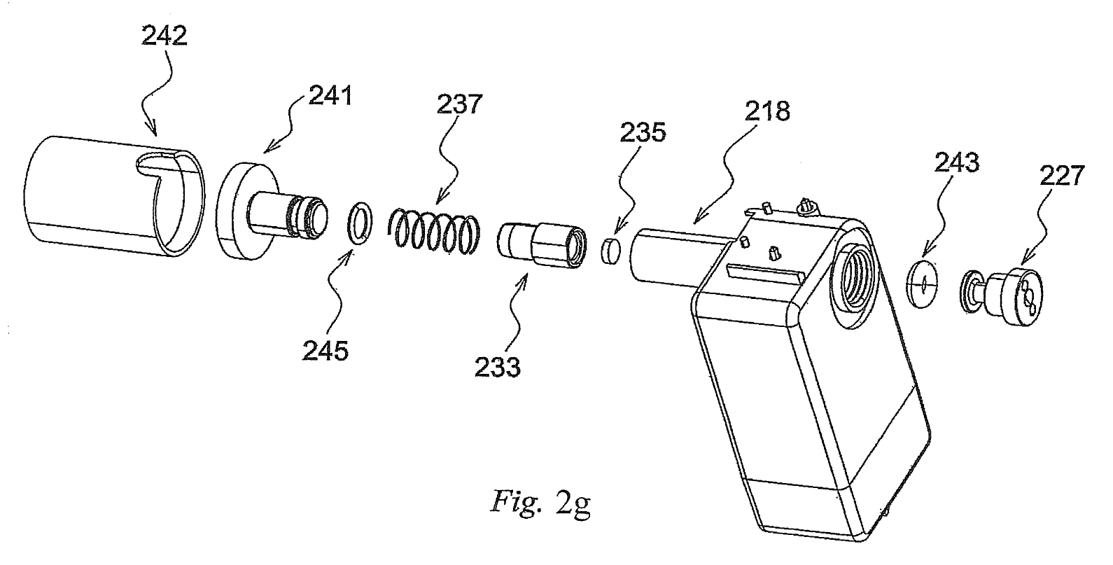

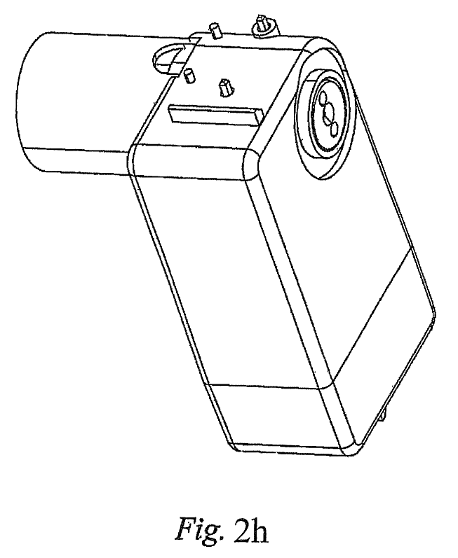

With reference to FIGS. 2a-2h, a manufacturing process for producing the integrated assembly 209 is described.

Firstly, as shown in FIG. 2a, the integral housing 210 including the reservoir 211 and the bobbin 217 is formed by molding a unitary unit from a polymeric material. The housing also includes the wall although not shown in FIG. 2a, extending between the bobbin 217 and the reservoir 211, and the delivery passage 223 extending through the wall for allowing fluid communication between the chamber of the reservoir and the bobbin. The reservoir 211 is open at one side 301 for allowing installation and housing of various components depending upon the particular requires of the desired application.

Then as shown in FIGS. 2a and 2d, the filter 247 and tube 249 are includes so as to cover the opening of the delivery passage 223.

In FIGS. 2c and 2d, a refill valve 215 is provided which allows the reservoir 211 to be refilled. The refill valve 215 is adapted to be engaged with the reservoir 211 via an aperture 303.

In FIGS. 2e and 2f, a reservoir cover 305 is shown which in the present embodiment is sonic-welded to close the open end of the reservoir such that deterrent substance can be filled into the reservoir.

As shown in FIGS. 2g and 2h, the valve 227 and gasket 243 are assembled into a portion of the bobbin 217 inside the housing 210; the seal 235, plunger 233, spring 237, stopper 241, gasket 245, windings 239 and metal tube 242 are assembled into/onto the extension 218 of the bobbin 217.

Then present invention, by provision of a unitary housing, provides significant advantages over existing bark control devices of the prior art. Additional manufacturing steps are required so as to form two separate main components as those typified, that is the reservoir and the bobbin, whereas the present invention provides a manufacturing process having significant less steps. Furthermore, the device of the prior art requires additional assembly and alignment time and techniques, such as those required to align and secure the two main components, by for example threaded screws 113, 115 extending from one side wall to the other, and to align the apertures 105, 107 on the side walls 109, 111 of the bobbin 101 and reservoir 103 with the assistance of o-ring 119, adding to complication and expense of manufacture, an inconvenience obviated by the present invention.

It will be understood that the invention disclosed and defined herein extends to all alternative combinations of two or more of the individual features mentioned or evident from the text or drawings. All of these different combinations constitute various alternative aspects of the invention. The foregoing describes an embodiment of the present invention and modifications, obvious to those skilled in the art can be made thereto, without departing from the scope of the present invention.

Although the invention is illustrated and described herein as embodied, it is nevertheless not intended to be limited to the details described, since various modifications and structural changes may be made therein without departing from the spirit of the invention and within the scope and range of equivalents of the claims.

Furthermore, it will be appreciated and understood that the words used in this specification to describe the present invention and its various embodiments are to be understood not only in the sense of their commonly defined meanings, but also to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result, without departing from the scope of the invention.

1. A device for deterring a dog from barking, comprising:
a sensor for detecting a bark from a dog and for generating an activation signal upon detection of the bark;
an integral housing including a reservoir for storing a bark deterrent substance, a bobbin integrated with the reservoir, a wall separating the bobbin from the reservoir, and an aperture extending through the wall for allowing fluid communication between the reservoir and the bobbin; and
a spray mechanism for delivery of a dose of the bark deterrent substance to the dog upon receipt of the activation signal from the sensor.

2. The device of claim 1, wherein the integral housing is formed from a unitary polymeric molding.

3. The device of claim 1, wherein the bobbin includes a valve assembly bobbin, and an extension tube extending from the valve assembly bobbin.

4. The device of claim 3, wherein the spray mechanism includes a valve assembly installed with the valve assembly bobbin for providing controlled delivery of the dose of bark deterrent substance to the dog.

5. The device of claim 4, wherein the spray mechanism further includes windings wound around the extension tube, the winding being for generation of an electromagnetic field upon receipt of the activation signal so as to controllably operate the valve assembly.

6. A process of fabricating a device for deterring a dog from barking, the process comprising:
providing an integral housing having a reservoir for storage of a bark deterrent substance, a bobbin integrated with the reservoir, a wall extending between the bobbin and the reservoir, and an aperture extending through the wall for allowing fluid communication between the reservoir and the bobbin; and
providing a spray mechanism in the bobbin for delivery of a dose of the bark deterrent substance to a dog upon receipt of an activation signal generated by a sensor upon sensing a bark from the dog.

7. The process of claim 6, further comprising forming the integral housing from a unitary molded polymeric material.

8. The process of claim 6, wherein the bobbin includes a valve assembly bobbin, and an extension tube extending from the valve assembly bobbin.

9. The process of claim 8, further comprising installing a valve assembly in the valve assembly bobbin for controllably delivering the dose of the bark deterrent substance to the dog.

10. The process of claim 9, further comprising providing windings around the extension tube, the windings being adapted to generate an electromagnetic field upon receipt of the activation signal so as to controllably operate the valve assembly.

11. A device for deterring a dog from barking comprising:
a reservoir portion for containment of a pressurized bark deterrent substance;
a bobbin portion defining a chamber therein, the chamber of the bobbin being in fluid communication with the reservoir portion via an aperture extending therebetween and for delivery of bark deterrent substance to the olfactory senses of a dog upon sensing that the dog is barking;
a sensor for detecting a bark from a dog and for generating an activation signal upon detection of the bark; and
a valve assembly located within the chamber of the bobbin, said valve assembly being adapted to deliver a dose of bark control substance upon receipt of an activation signal from the sensor.

12. The device according to claim 11, wherein the reservoir portion and bobbin portion are unitary formed and passage therebetween provided by the aperture is provided by the aperture extending from the chamber of the bobbin portion through an intermediate formation between the bobbin portion and reservoir portion and into the reservoir portion.

13. The device according to claim 11, wherein the reservoir portion substantially defines a housing of the device, and the bobbin portion extends from within the reservoir portion to external of the housing.

14. The device according to claim 11, wherein the housing, reservoir portion and bobbin portion are integrally formed as a unitary structure.

15. The device according to claim 11, wherein the housing, reservoir portion and bobbin portion are integrally formed as a unitary structure.

16. The device according to claim 11, wherein the valve assembly includes a biased plunger located within the passage of the bobbin wherein the plunger is biased and adapted to seal the aperture absent receiving an activation signal from the sensor to allow for pressurisation of the deterrent substance within the reservoir portion.

17. The device according to claim 16, wherein the valve assembly further includes a valve having a discharge channel in fluid communication with a nozzle for discharge of deterrent substance.

18. The device according to claim 17, wherein the plunger is provided so as to seal both the discharge channel and the aperture absent receiving an activation signal from the sensor.

19. The device according to claim 11, wherein the valve assembly includes a solenoid coil for effecting operation of the valve upon receipt of an activation signal from the sensor.

20. The device of claim 2, wherein the bobbin includes a valve assembly bobbin, and an extension tube extending from the valve assembly bobbin.
